(19) United States
(12) Patent Application Publication
(10) Pub. No.: US 2018/0146312 A1
(43) Pub. Date: May 24, 2018

(54) VOICE TRANSFER SYSTEM

(71) Applicant: PRODRONE CO., LTD., Nagoya-shi, Aichi (JP)

(72) Inventors: Masakazu KONO, Nagoya-shi, Aichi (JP); Kazuo ICHIHARA, Nagoya-shi, Aichi (JP)

(73) Assignee: PRODRONE CO., LTD., Nagoya-shi, Aichi (JP)

(21) Appl. No.: 15/568,259

(22) PCT Filed: Apr. 20, 2016
(86) PCT No.: PCT/JP2016/062485

§ 371 Date: Dec. 20, 2017

(30) Foreign Application Priority Data
Apr. 20, 2015 (JP) 2015-086312

(51) Int. Cl. H04R 27/00; B64C 39/02; H04Q 9/02; G06K 9/00

(52) U.S. Cl. CPC H04R 27/00; B64C 39/024; B64C 2201/12; G06K 9/00369; H04Q 9/02

(57) ABSTRACT

A system that realizes transferring voice effectively, at low cost, and safely in a broad area and even in a case where there is a sparse number of target persons to whom voice is intended to be transferred in an area. This is solved by a voice transfer system including an unmanned aerial vehicle capable of standing still at one point in the air and a supervisory center capable of wireless communication with the unmanned aerial vehicle, wherein the unmanned aerial vehicle includes voice output means capable of outputting voice.

### TECHNICAL FIELD

The present invention relates to a system that provides voice information.

### BACKGROUND ART

Conventionally, miniature unmanned aerial vehicles which are typified by unmanned helicopters for industrial use have been expensive and hard to obtain, and manipulative skills have been needed to make them fly stably. However, considerable improvement has lately been made in a suite of sensors and software which are used for attitude control and autonomous flying of unmanned aerial vehicles, and consequently, maneuverability of unmanned aerial vehicles has improved significantly as well as high-performance airframes of such vehicles have become available at a moderate price. Against this background, attempts are now made to apply, especially, miniature multicopters to diverse missions in a wide range of fields, not only for hobby purposes.

A scheme for transferring voice to the public is generally called a PA (Public Address) system. The PA system is used for purposes of making announcement in retail premises, guiding a crowd of people for evacuation at a time of disaster, speech for election and advertising on the street. In local regions and suburban areas, the PA system is also used to transfer a variety of information to community people, as a part of a radio broadcasting scheme for disaster preventive administration.

### CITATION LIST

### Patent Literature

PTL1: JP 2012-173952 A

### SUMMARY OF INVENTION

### Technical Problem

In a case where the PA system is used in a broad area, because the range that voice reaches is limited, it is required to augment the volume of sound produced by a voice amplifying device to make the sound louder, to provide information toward a particular direction using a directional voice amplifying device, or to install many voice amplifying devices.

However, if the volume of sound produced by a voice amplifying device is augmented to make the sound louder, the sound volume may become so large as to be uncomfortable in the vicinity of the installation site of the voice amplifying device. Meanwhile, if a directional voice amplifying device is used, design to deploy the voice amplifying device becomes difficult because characteristics of a landform and an installation site need to be taken into consideration, and in most cases, the purpose as the PA system cannot be achieved. In addition, if many voice amplifying devices are installed, because the cost of installing the voice amplifying devices increases correspondingly to the largeness of an area to be covered, cost efficiency becomes poor when there is only a small number of target persons to whom information is intended to be transferred.

Additionally, a way in which a person drives and cruises a vehicle in which a voice amplifying device is mounted around an area may be used in some situations. Again, in a case where this method is used, it is hard to transfer information effectively if the area is broad. Also, if information to be transferred is emergency information such as disaster information, safety of the person who rides on the cruising vehicle also becomes a problem.

In consideration of the problems noted above, a problem to be solved by the present invention resides in providing a system that realizes transferring voice effectively, at low cost, and safely in a broad area and even in a case where there is only a sparse number of target persons in an area.

### Solution to Problem

To solve the foregoing problem, a voice transfer system of the present invention includes an unmanned aerial vehicle capable of standing still at one point in the air and a supervisory center capable of wireless communication with the unmanned aerial vehicle, wherein the unmanned aerial vehicle includes voice output means capable of outputting voice.

The above voice transfer system is such that the unmanned aerial vehicle can output voice through the voice output means by wireless communication from the supervisory center or while flying along a predetermined cruising route autonomously (such an autonomous flight will be referred to as “autopilot” hereinafter).

According to the voice transfer system of the present invention, information can be transferred to target persons by voice, and therefore, it is possible to transfer specific and detailed information, as compared with an instance of transferring information by mechanical sound such as a buzzer.

Also, the voice transfer system of the present invention enables it to transfer voice from above, while causing the unmanned aerial vehicle to fly. Hence, there is no need to output louder voice to make far-reaching announcement of information and voice transfer to be performed is insusceptible to a landform, an obstacle, or the like. Moreover, because the unmanned aerial vehicle itself can move, there is no need to distribute and deploy many devices.

In addition, because no person is present in the unmanned aerial vehicle, there is no need to take the safety of a person into consideration, even though information to be transferred is disaster information.

Thereby, it would become possible to realize transferring voice effectively, at low cost, and safely in a broad area and even in a case where there is a sparse number of target persons to whom voice is intended to be transferred in an area.

In addition, it is preferable that the unmanned aerial vehicle includes voice input means for taking in voice of a target person to whom voice is intended to be transferred.

It is also preferable that the supervisory center includes voice output means capable of outputting voice taken in by the voice input means of the unmanned aerial vehicle.

By equipping the unmanned aerial vehicle with the voice input means, it becomes possible to transfer voice from the target person to the supervisory center, not only transferring voice in one direction, and bidirectional information exchange becomes possible.

It is also preferable that the unmanned aerial vehicle is capable of selectively reproducing one of a plurality of voice data pieces recorded in advance, depending on predefined conditions or as instructed from the supervisory center.

The unmanned aerial vehicle is enabled to selectively reproduce one of a plurality of voice data pieces recorded in advance; thereby, it would become possible to transfer information more appropriately depending on circumstances.

It is also preferable that the plurality of voice data pieces are registered in voice data storing means of the supervisory center and the unmanned aerial vehicle is capable of reproducing the voice data selected by the supervisory center, as instructed from the supervisory center.

A plurality of voice data pieces are registered in the voice data storing unit of the supervisory center and the unmanned aerial vehicle is enabled to selectively reproduce one of these data pieces; thereby, it would become possible to consolidate and manage voice data at the supervisory center.

It is also preferable that voice that has been input through the voice input means of the supervisory center can be output through the voice output means of the unmanned aerial vehicle.

Voice that has been input through the voice input means of the supervisory center can be transferred to a target person through the voice output means of the unmanned aerial vehicle; thereby, it would become possible that the supervisory center and the target person converse with each other in real time.

It is also preferable that the unmanned aerial vehicle includes image capturing means and the supervisory center includes display means capable of displaying images captured by the image capturing means.

By equipping the unmanned aerial vehicle with the image capturing means, the operator of the supervisory center can visually observe a surrounding scene and the presence of a target person to whom information is intended to be transferred from images or video captured by the image capturing means of the unmanned aerial vehicle.

It is also preferable that the unmanned aerial vehicle includes a human sensor.

By equipping the unmanned aerial vehicle with the human sensor, information can be transferred efficiently, for example, in such a way as to detect the presence of a person and cause the airframe to approach the person. Such a configuration is effective especially in a case where target persons to whom voice is intended to be transferred are sparsely located in an area and a case where the unmanned aerial vehicle is cased to fly automatically in a cruising flight.

### Advantageous Effects of Invention

As described above, according to the voice transfer system pertaining to the present invention, it would become possible to transfer voice effectively, at low cost, and safely in a broad area and even in a case where target persons are sparsely located in an area.

### BRIEF DESCRIPTION OF DRAWINGS

FIG. 1 is a schematic diagram depicting a functional configuration of a multicopter in an embodiment described herein.

FIG. 2 is a schematic diagram depicting a functional configuration of a supervisory center in the present embodiment.

FIG. 3 is a flowchart illustrating one example of a voice transfer method by the voice transfer system.

### DESCRIPTION OF EMBODIMENTS

In the following, an embodiment of the present invention will be described in detail with the aid of the drawings. Components with an identical reference designator in the present specification and drawings are identical to one another.

[Overall Configuration]

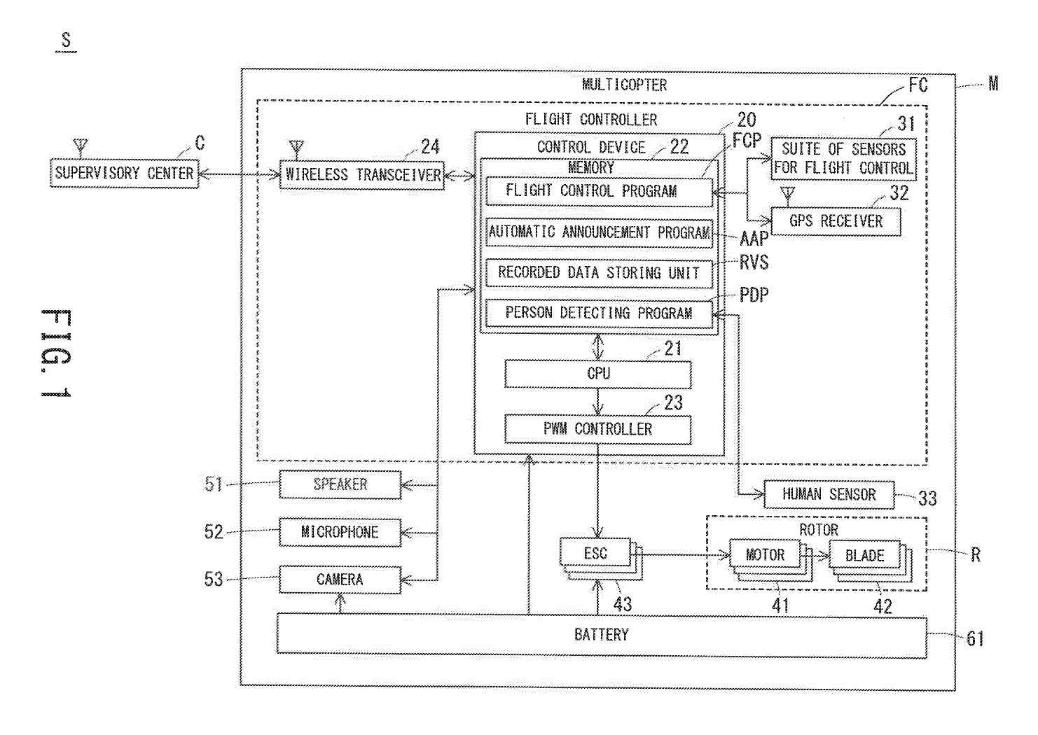

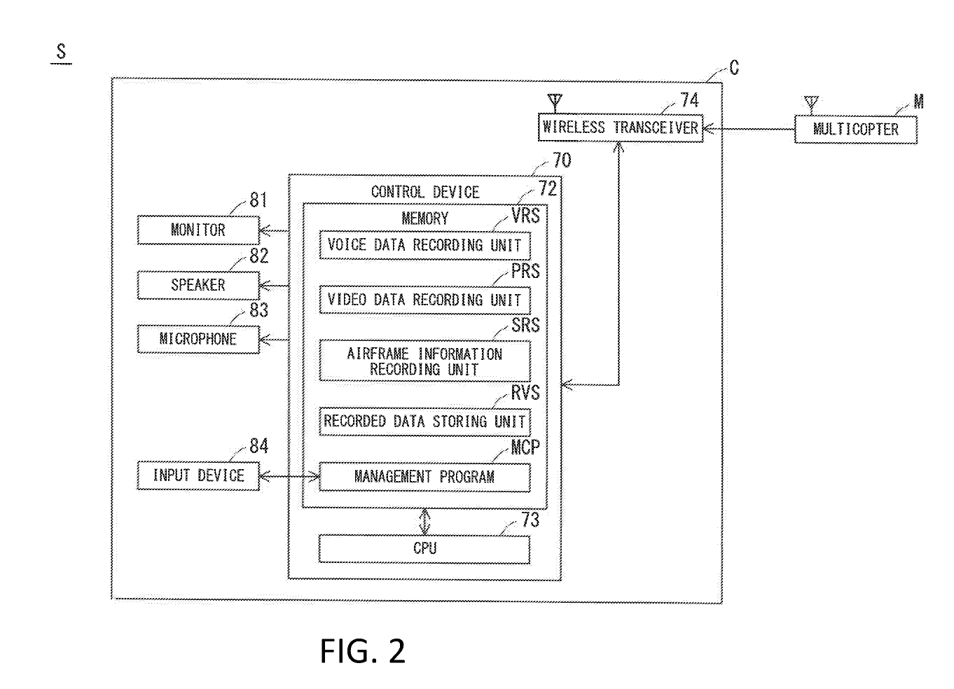

A voice transfer system S of the present embodiment is comprised of a multicopter M which is an unmanned aerial vehicle and a supervisory center C. FIG. 1 is a block diagram depicting a functional configuration of the multicopter M and FIG. 2 is a block diagram depicting a functional configuration of the supervisory center C. Now, “voice” termed in the present invention means human voice, but recorded voice and artificially produced voice are also included therein.

[Multicopter Configuration]

In the airframe of the multicopter M, a flight controller FC, rotors R which are a plurality of rotary wings, ESCs 43 (Electric Speed Controllers) which control rotation of the rotors R, a wireless transceiver 24 for wireless communication with the supervisory center C, and a battery 61 which is a source of power supply are mainly mounted.

Each rotor R is comprised of a motor 41 which is a DC motor and a blade 42 installed on the output shaft of the motor. An ESC 43 is connected to the motor 41 of the rotor R and is a device which rotates the motor 41 at a speed commanded from the flight controller FC. Now, the number of rotors of the multicopter M is not limited specifically and can be changed appropriately depending on, inter alia, required flight stability and allowable cost in a range from a helicopter with two rotors R (one rotor R, if a tail rotor is excluded) to an octocopter with eight rotors R; the multicopter may be further equipped with rotors R more than eight ones.

The flight controller FC includes a control device 20 which is a microcomputer. The control device 20 includes a CPU 21 which is a central processing unit, a memory 22 which is a storage device such as ROM and RAM, and a PWM controller 23 which controls rotating speed and rotational rate (which will hereinafter be simply referred to as “rotating speed” as a collective term) of each motor 41 via the ESC 43.

The flight controller FC further includes a suite of sensors 31 for flight control and a GPS receiver 32 (which may hereinafter be referred to also as “sensors and other equipment”) and they are connected to the control device 20. The suite of sensors 31 for flight control of the multicopter M in the present embodiment includes an acceleration sensor, an angular velocity sensor, an atmospheric pressure sensor (an altitude sensor), a geomagnetic sensor (a direction sensor), etc. Through these sensors and other equipment, the control device 20 is adapted to be able to acquire the multicopter's positional information including latitude/longitude and flight altitude during a flight and a heading azimuth, in addition to a tilt and turn of the airframe.

In the memory 22 of the control device 20, a flight control program FCP is stored in which a flight control algorithm is programmed to control attitude and basic flying operations of the multicopter M during a flight. The flight control program FCP causes the multicopter M to fly, while adjusting the rotating speed of each rotor R and correcting the airframe attitude and positional misalignment based on the current position acquired from the sensors and other equipment. Now, by setting in advance, inter alia, a flight route, latitude/longitude, and flight altitude for parameters of an automatic announcement program AAP to be described later, it is possible to cause the multicopter M in the present embodiment to fly autonomously, cruising around a predetermined area by autopilot. It is also possible to manually pilot the multicopter M directly from the supervisory center C.

The multicopter M includes a speaker 51 as voice output means. The multicopter M also includes a recorded data storing unit RVS in which voice data as recorded voice to be reproduced through the speaker 51 and a unique ID identifying that data have been stored in a mapped manner to each other. The multicopter M also includes an automatic announcement program AAP which automatically reproduces voice data in the recorded data storing unit RVS through the speaker 51 during a cruising flight by autopilot. The multicopter M also includes a person detecting program PDP which detects the presence of a person who is a target person to whom voice is intended to be transferred (hereinafter referred to as a “target person”) from an output value of a human sensor 33 (hereinafter, the human sensor 33 and the person detecting program 33 may be referred to as the human sensor 33 comprehensively).

The multicopter M in the present embodiment outputs voice and transfers information to target persons, and therefore, the multicopter is adapted to be able to transfer more specific and detailed information to target persons, as compared with an instance of transferring information by mechanical sound such as a buzzer. In addition, because it is possible to transfer voice from above while the multicopter M is caused to fly, there is no need to output louder voice to make far-reaching announcement of information and such voice thus transferred is insusceptible to a landform, an obstacle, or the like. Moreover, because the multicopter M itself can move, there is no need to distribute and deploy many voice amplifying devices. In addition, because no person is present in the multicopter M, there is no need to take the safety of a person into consideration, even though information to be transferred is emergency information such as disaster information.

The multicopter M is further equipped with a microphone 52 which takes in voice of a target person and a camera 53 which is a video capturing unit which captures a video of a scene surrounding the airframe.

Now, the multicopter M in the present embodiment is configured to transfer voice taken in by the microphone 52 and a video captured by the camera 53 directly to the supervisory center C; however, it can be configured to record these voice and video into the memory 22 and bring them back to the supervisory center C.

The multicopter not only simply reproduces routine recorded data, but also can output, through the speaker 51, voice data being transmitted from the supervisory center C via the wireless transceiver 24 of the multicopter M, or based on a voice data ID being transmitted from the supervisory center C, can retrieve voice data mapped to the ID from the recorded data storing unit RVS and reproduce the voice data. Furthermore, depending on predefined conditions, the automatic announcement program AAP is adapted to be able to select voice data to be reproduced from the recorded data storing unit RVS automatically.

The human sensor 33 in the present embodiment is a sensor which detects a heat source using infrared rays. As a human sensor in the present invention, alternatives such as a sensor which detects a change in temperature and a program which identifies a moving object from a video (a plurality of images) captured by the camera are conceivable.

Although the multicopter M equipped with a plurality of rotary wings is used in the present embodiment, an unmanned aerial vehicle of the present invention encompasses another type of unmanned aerial vehicle such as an unmanned airship equipped with a source of trust, provided that the unmanned aerial vehicle is able to stand still at one point in the air.

[Configuration of the Supervisory Center]

The supervisory center C is equipped with a wireless transceiver 74 for communication with the multicopter M and sends an instruction to the multicopter M, while monitoring airframe information and its surrounding information being transmitted from the multicopter M. The supervisory center C in the present embodiment is capable of supervising and controlling not only a single multicopter M, but also a plurality of multicopters M at the same time.

The supervisory center C includes a control device 70 which processes information received from the multicopter M and information to be transmitted to the multicopter M. The control device 70 includes a CPU 73 which is a central processing unit and a memory 72 which is a storage device such as ROM and RAM. To the control device 70, a monitor 81, a speaker 82, a microphone 83, and an input device 84 for interfacing with an operator are connected. The operator operates the supervisory center C via a management program MCP through the input device 84. The supervisory center C may be a manned station like an operation center or a device such as, e.g., a notebook type personal computer.

The speaker 82 of the supervisory center C reproduces voice collected by the microphone 52 of the multicopter M. The monitor 81 displays images or video (hereinafter simply referred to as “video or the like”) captured by the camera 53 of the multicopter M. On the monitor 81, not only such video or the like, but also airframe information such as a flight position of the multicopter M, the ID of voice data being reproduced, and presence/absence of a target person detected is displayed at the same time. Upon receiving voice, video or the like, or airframe information from the multicopter M, the supervisory center C displays them on the monitor 81 and in addition, records each of them into a voice data recording unit VRS, a video data storing unit PRS, and an airframe information recording unit SRS which are areas in the memory 72. Contents recorded in these voice data recording unit VRS, video data storing unit PRS, and airframe information recording unit SRS can be displayed on the monitor 81 again or reproduced through the speaker 82 at a later time, when operated by the operator.

In a recorded data storing unit RVS which is an area in the memory 72, voice data as recorded voice and a unique ID identifying that data are stored in a mapped manner to each other, as is the case for the recorded data storing unit RVS in the multicopter M. The kind of voice data stored in the recorded data storing unit RVS in the supervisory center C and the kind of voice data stored in the recorded data storing unit RVS in the multicopter M may be the same or different.

By inputting voice through the microphone, the operator can register new voice data into the recorded data storing unit RVS of the supervisory center C. By transmitting a voice data ID to the multicopter M, the operator causes the multicopter M to select the voice data to be reproduced from the recorded data storing unit RVS of the multicopter M. Or by specifying an ID in the recorded data storing unit RVS of the supervisory center C, the operator can transmit the corresponding voice data to the multicopter M and cause the multicopter to reproduce that data. Also, the operator can upload the contents of the recorded data storing unit RVS of the supervisory center C to the multicopter M and overwrite the contents of the recorded data storing unit RVS in the multicopter M with the uploaded contents. Furthermore, the operator can transmit contents which have been input through the microphone 83 to the multicopter M and cause the multicopter M to output the contents through its speaker 51.

As described hereinbefore, in the voice transfer system S of the present embodiment, the multicopter M is equipped with the speaker 51 and the microphone 52 and the supervisory center C is also equipped with the speaker 82 and microphone 83; thereby, it is enabled that the operator of the supervisory center C and a target person can engage in conversation with each other.

[Voice Transfer Procedure]

For a single multicopter M or a plurality of multicopters M, the supervisory center C (operator) first sets an area and a route that the multicopter(s) will cruise for the automatic announcement program AAP in each multicopter M. A cruising area and a route can be specified based on map data. Alternatively, for instance, if the supervisory center C has a portable device such as a notebook type personal computer and when the operator can visually locate a target person or a group of target persons, it is also possible to specify a relative position between the operator's current value and the target person or the group of target persons.

Taking account of, inter alia, duration for which the multicopter M can fly and an area-specific time limit, for the automatic announcement program AAP, the supervisory center C (operator) can set the following: the number of times that the multicopter will cruise around the area; maximum cursing time; the number of times that announcement to target persons will be repeated; and an operation after completion of announcement. Now, “announcement” termed herein refers to reproducing voice data toward target persons.

For each multicopter M, the supervisory center C (operator) sets voice data for announcement in the cruising area for the automatic announcement program AAP. Voice data for announcement may be selected from the recorded data storing unit RVS in the multicopter M, as described previously, and may be selected from the recorded data storing unit RVS in ach multicopter M.

In addition, in the automatic announcement program AAP, a setup can also be specified to select voice data automatically, for example, depending on conditions of a flight position and date and time at announcement. Moreover, a setup can also be specified to select voice data for announcement, for example, depending on a temperature condition, if the suite of sensors 31 for flight control and the human sensor 33 can acquire temperature information, or depending on a humidity condition, if humidity information can be acquired.

The automatic announcement program AAP in the present embodiment not only reproduces voice data while cruising along a setup route, but also can specify an action to detect a target person through the human sensor 33, approach the target person, and make announcement.

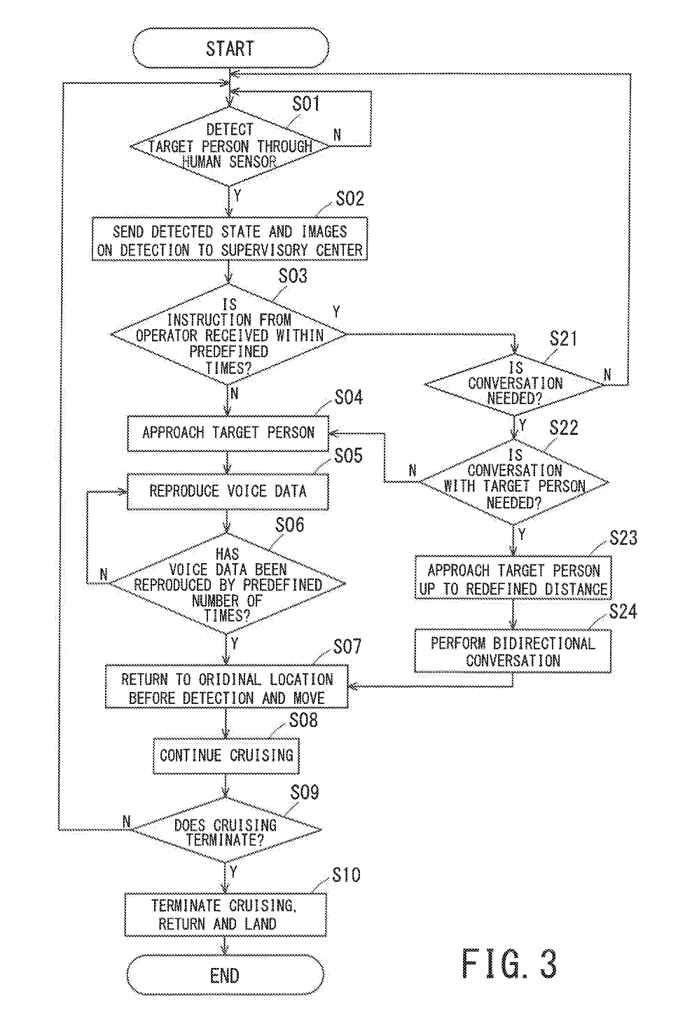

FIG. 3 is a flowchart illustrating the announcement operation. As illustrated in FIG. 3, when the multicopter M detects a target person through the human sensor 33 (S01) while cruising around the setup area, the automatic announcement program AAP sends that event and images of surroundings captured by the camera 53 to the supervisory center C (S02).

If the operator at the supervisory center C is not aware of this event and gives no instruction to the multicopter M within a predefined time (S03: N), the automatic announcement program AAP starts an operation of automatic announcement to the target person.

The automatic announcement program AAP causes the multicopter M to approach the target person up to a predefined distance and causes the multicopter M to stand still at one point in the air (S04). Then, the multicopter reproduces voice data selected in advance or automatically selected depending on the situation at the time by a predetermined number of times (S05). After completion of reproducing the voice data (S06: Y), the automatic announcement program AAP returns the multicopter M to the same position as it was when it detected the target person (S07) and restarts a cruising flight (S08).

If an instruction is given to the multicopter M from the supervisory center C within a predefined time after the multicopter detects a target person and notifies the supervisory center C of that event (S03: Y) and if the instruction indicates that announcement is not needed, the multicopter restarts the cruising flight, ignoring the target person (S21: N). It is hard for most human sensors which are generally prevalent to distinguish between a person and an animal. The above instruction is given, for example, in a case where the target person determined as a person turns out to be an animal by the transmitted images.

Otherwise, if the operator determines that announcement is needed (S21: Y) and if the operator determines that bidirectional voice communication, i.e., conversation is needed (S22: Y), the operator instructs the multicopter M to perform conversation.

After the automatic announcement program AAP receives this instruction and causes the multicopter to approach the target person up to a predefined distance (S23), the automatic announcement program AAP enables the microphone 52 and the speaker 51 of the multicopter M as well as the microphone 83 and the speaker 82 of the supervisory center and sets both in a state that bidirectional voice communication is enabled (S24). In this case, the speaker 51 of the multicopter M is not limited to a voice amplifier; for example, a device like a phone receiver equipped with the microphone 52 may be caused to descend a position allowing the target person to hold it. Also, as for the microphone 52, a microphone having downward directionality may be caused to descend overhead the target person. This can reduce noise introduced in conversation.

After the conversation has finished, the operator notifies the automatic announcement program AAP that the conversation has finished and the notified automatic announcement program AAP returns the multicopter M to the same position as it was when it detected the target person (S07) and restarts the cruising flight (S08).

This function is effective especially in a case where there are a sparse number of target persons in a broad area.

Now, in the above procedure, if the multicopter M is not equipped with the camera 53, data representing the state detected by the human sensor 33 is only transmitted to the supervisory center C. A subsequent procedure is the same as the above procedure.

When the cruising flight of the multicopter M terminates (S09), the automatic announcement program AAP causes the multicopter M to return and land at a departure and arrival site (S10).

While an embodiment of the present invention has been described hereinbefore, the present invention is not limited to the foregoing embodiment and can be modified in various ways without departing from the gist of the present invention.

1. A voice transfer system comprising:
an unmanned aerial vehicle capable of standing still at one point in the air; and
a supervisory center capable of wireless communication with the unmanned aerial vehicle,
wherein the unmanned aerial vehicle includes voice output means capable of outputting voice.

2. The voice transfer system according to claim 1, wherein the unmanned aerial vehicle includes voice input means for taking in voice of a target person to whom voice is intended to be transferred.

3. The voice transfer system according to claim 2, wherein the supervisory center includes voice output means capable of outputting voice taken in by the voice input means of the unmanned aerial vehicle.
The voice transfer system according to claim 1, wherein the unmanned aerial vehicle is capable of selectively reproducing one of a plurality of voice data pieces recorded in advance, depending on predefined conditions or as instructed from the supervisory center.

5. The voice transfer system according to claim 4,
wherein the plurality of voice data pieces are registered in voice data storing means of the supervisory center; and
the unmanned aerial vehicle is capable of reproducing the voice data selected by the supervisory center, as instructed from the supervisory center.

6. The voice transfer system according to claim 3,
wherein the supervisory center includes voice input means; and;
voice that has been input through the voice input means of the supervisory center can be output through the voice output means of the unmanned aerial vehicle.

7. The voice transfer system according to claim 1,
wherein the unmanned aerial vehicle includes image capturing means; and
the supervisory center includes display means capable of displaying images captured by the image capturing means.

8. The voice transfer system according to claim 1, wherein the unmanned aerial vehicle includes a human sensor.

9. The voice transfer system according to claim 2,
wherein the unmanned aerial vehicle includes image capturing means; and
the supervisory center includes display means capable of displaying images captured by the image capturing means.

10. The voice transfer system according to claim 3,
wherein the unmanned aerial vehicle includes image capturing means; and
the supervisory center includes display means capable of displaying images captured by the image capturing means.

11. The voice transfer system according to claim 4,
wherein the unmanned aerial vehicle includes image capturing means; and
the supervisory center includes display means capable of displaying images captured by the image capturing means.

12. The voice transfer system according to claim 5,
wherein the unmanned aerial vehicle includes image capturing means; and
the supervisory center includes display means capable of displaying images captured by the image capturing means.

13. The voice transfer system according to claim 6,
wherein the unmanned aerial vehicle includes image capturing means; and
the supervisory center includes display means capable of displaying images captured by the image capturing means.
